(19) United States
(12) Patent Application Publication
(10) Pub. No.: US 2024/0266563 A1
(43) Pub. Date: Aug. 8, 2024

(54) FUEL CELL EXHAUST-GAS SYSTEM

(71) Applicant: Purem GmbH, Neunkirchen (DE)

(72) Inventors: Jochen Hammer, Stuttgart (DE); Peter Wink, Goeppingen (DE); Michael Mayer, Bempflingen (DE); Gerd Gaiser, Reutlingen (DE); Patrick Schaller, Bopfingen (DE); Tadeusz-Jozef Juroszek, Esslingen (DE)

(21) Appl. No.: 18/434,436

(22) Filed: Feb. 6, 2024

(30) Foreign Application Priority Data
Feb. 7, 2023 (DE) 10 2023 102 864.2

(51) Int. Cl. H01M 8/04119; B60R 16/03; H01M 8/04014; H01M 8/04029

(52) U.S. Cl. CPC H01M 8/04164; H01M 8/04014; H01M 8/04029; B60R 16/03; H01M 2250/20

(57) ABSTRACT

A fuel cell exhaust-gas system includes at least one condenser for receiving water-containing fuel cell exhaust gas that has been discharged from a fuel cell and for discharging water-depleted fuel cell exhaust gas. The at least one condenser includes a separator for separating off water that has been condensed out of the water-containing fuel cell exhaust gas that has been fed to the at least one condenser and at least one heat exchanger, wherein the water-containing fuel cell exhaust gas that is fed to at least one condenser, and water-depleted fuel cell exhaust gas that has been discharged from at least one condenser, can flow through the at least one heat exchanger in order for heat of the water-containing fuel cell exhaust gas to be transferred to the water-depleted fuel cell exhaust gas.

### CROSS-REFERENCE TO RELATED APPLICATIONS

This application claims priority of German patent application no. 10 2023 102 864.2, filed Feb. 7, 2023, the entire content of which is incorporated herein by reference.

### TECHNICAL FIELD

The present disclosure relates to a fuel cell exhaust-gas system via which, for example in a vehicle, the fuel cell exhaust gas emitted by a fuel cell that is operated for the purposes of generating electrical energy can be discharged to the surroundings.

### BACKGROUND

To generate electrical energy in a fuel cell, hydrogen or a hydrogen-containing gas is fed to an anode region of the fuel cell and oxygen or an oxygen-containing gas, for example air, is fed to a cathode region of the fuel cell. A hydrogen-depleted gas is discharged as fuel cell exhaust gas at an anode exhaust-gas outlet of the anode region of the fuel cell. An oxygen-depleted gas is discharged as fuel cell exhaust gas at a cathode exhaust-gas outlet of the cathode region of the fuel cell. Depending on the type of fuel cell, primarily the fuel cell exhaust gas discharged at the cathode region of the fuel cell or primarily the fuel cell exhaust gas discharged at the anode region of the fuel cell contains a relatively high fraction of water or water vapor. If fuel cell exhaust gas that is highly enriched with water vapor, with a relative humidity in the range of 90-100%, is discharged via a fuel cell exhaust-gas system to the surroundings, there is the risk, in particular in the presence of relatively low ambient temperatures, that the temperature of the fuel cell exhaust-gas decreases significantly upon contact with the ambient air, which can cause water to condense out of the fuel cell exhaust gas and thus cause intense fog formation. Such fog formation can be perceived as unpleasant and undesired simply owing to its visual appearance, and, in particular presence of very low ambient temperatures, leads to the risk of ice forming on the underlying surface under the vehicle if the vehicle is stationary in the region in which the fuel cell exhaust gas is being released to the surroundings.

### SUMMARY

An object of the present disclosure is to provide a fuel cell exhaust-gas system, in particular for a vehicle, via which fog formation in the fuel cell exhaust gas that is discharged to the surroundings can be substantially prevented.

The object is achieved according to the disclosure via a fuel cell exhaust-gas system, in particular for a vehicle. The fuel cell exhaust-gas system includes at least one condenser unit for receiving water-containing fuel cell exhaust gas that has been discharged from a fuel cell and for discharging water-depleted fuel cell exhaust gas, wherein the at least one condenser unit includes a separator unit for separating off water that has been condensed out of the water-containing fuel cell exhaust gas that has been fed to the at least one condenser unit, and at least one heat exchanger unit, wherein the water-containing fuel cell exhaust gas that is fed to at least one condenser unit, and water-depleted fuel cell exhaust gas that has been discharged from at least one condenser unit, can flow through the at least one heat exchanger unit in order for heat of the water-containing fuel cell exhaust gas to be transferred to the water-depleted fuel cell exhaust gas.

Owing to the thermal interaction that is provided, in the fuel cell exhaust-gas system configured in accordance with the disclosure, between the water-containing fuel cell exhaust gas emitted by a fuel cell at relatively high temperature and the fuel cell exhaust gas that has been cooled and depleted of water in a condenser unit, it is firstly the case that heat is extracted from the water-containing fuel cell exhaust gas that is fed to a condenser unit, thus assisting the process of condensation in a downstream condenser unit. Secondly, the water-depleted fuel cell exhaust gas that is discharged at reduced temperature from a condenser unit is warmed owing to this thermal interaction, whereby the relative humidity thereof decreases to a value significantly below 100%, preferably below 90%. This prevents a situation in which, when the water-depleted fuel cell exhaust gas, from which water or water vapor has however not been eliminated entirely, comes into contact with the ambient air, the degree of water saturation of the fuel cell exhaust gas spontaneously increases to over 100%; in this way, fog formation in fuel cell exhaust gas that is discharged to the surroundings even in the presence of relatively low ambient temperatures can be significantly reduced.

For a configuration that further reduces fog formation when fuel cell exhaust gas is discharged to the surroundings, it is proposed
that at least two condenser units and at least two heat exchanger units are provided,
that the water-containing fuel cell exhaust gas that is fed to a first condenser unit of the at least two condenser units can flow through a first heat exchanger unit of the at least two heat exchanger units,
that the water-containing fuel cell exhaust gas that is fed to a second condenser unit of the at least two condenser units can flow through a second heat exchanger unit of the at least two heat exchanger units,
that the water-depleted fuel cell exhaust gas that has been discharged from the second condenser unit can flow through the first heat exchanger unit in order for heat of the water-containing fuel cell exhaust gas that is fed to the first condenser unit to be transferred to the water-depleted fuel cell exhaust gas that has been discharged from the second condenser unit, and
that the water-depleted fuel cell exhaust gas that has been discharged from the first condenser unit can flow through the second heat exchanger unit in order for heat of the water-containing fuel cell exhaust gas that is fed to the second condenser unit to be transferred to the water-depleted fuel cell exhaust gas that has been discharged from the first condenser unit.

For the purposes of cooling the water-containing fuel cell exhaust gas, it may be possible for a cooling medium to flow through and/or around the at least one condenser unit.

Here, the cooling medium may include ambient air. Alternatively or in addition, the cooling medium may include a cooling liquid, which may for example circulate in a refrigerant circuit that utilizes the cooling liquid as refrigerant.

For efficient thermal interaction between the cooling medium and the fuel cell exhaust gas that flows through the at least one condenser unit, it is proposed that the at least one condenser unit includes a multiplicity of cooling medium channels, through which the cooling medium can flow, and/or a multiplicity of heat transfer fins, around which the cooling medium can flow.

The disclosure furthermore relates to a fuel cell system including a fuel cell and including a fuel cell exhaust-gas system configured according to the disclosure, which is assigned to the fuel cell.

### BRIEF DESCRIPTION OF DRAWINGS

The invention will now be described with reference to the drawings wherein:

FIG. 1 is a diagrammatic illustration of a fuel cell system having a fuel cell and having a fuel cell exhaust-gas system;

FIG. 2 is a diagrammatic illustration of an alternative configuration of a fuel cell exhaust-gas system; and,

FIG. 3 is a diagrammatic illustration of a condenser unit for a fuel cell exhaust-gas system with different configuration options for the thermal interaction of a cooling medium with the condenser unit.

### DETAILED DESCRIPTION

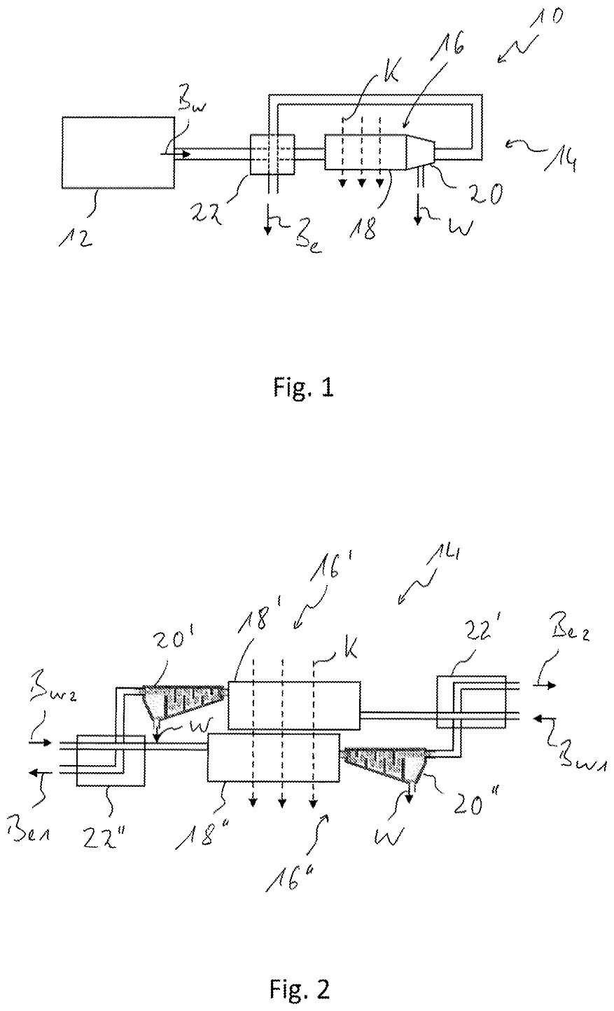

FIG. 1 is a diagrammatic illustration of a fuel cell system, which is denoted generally by 10. The fuel cell system 10, which is used for example in a vehicle for the purposes of generating electrical energy, includes a fuel cell 12, which is for example constructed with a fuel cell module. During operation, hydrogen or a hydrogen-containing gas is fed to the fuel cell 12 at an inlet (not illustrated) of an anode region, and oxygen or an oxygen-containing gas, in particular air, is fed to the fuel cell 12 at an inlet (not shown) of a cathode region. A hydrogen-depleted gas is discharged at an anode exhaust-gas outlet (not shown). An oxygen-depleted gas is discharged at a cathode exhaust-gas outlet of the cathode region of the fuel cell 12. These two exhaust-gas flows, or at least one of these two exhaust-gas flows, is discharged, as water-containing or water-vapor-containing fuel cell exhaust gas B_{w}, into a fuel cell exhaust-gas system 14 of the fuel cell system 10, via which a water-depleted fuel cell exhaust gas Bₑ, from which water or water vapor has been partially eliminated in the manner described below, is discharged to the surroundings.

The fuel cell exhaust-gas system 14 includes, as a central system region, a condenser unit that is denoted generally by 16. The condenser unit 16 includes a condenser region 18 in which, for example by thermal interaction with a cooling medium K, the water-containing fuel cell exhaust gas B_{w} is cooled such that water W is condensed out of it. The condenser region 18 is followed by a separator unit which is denoted generally by 20 and in which the water W that has been condensed out of the water-containing fuel cell exhaust gas B_{w} is separated off, such that the water-depleted fuel cell exhaust gas Bₑ exits the condenser unit 16. The condenser region 18 and the separator unit 20 of the condenser unit 16 may be structurally linked to one another as one assembly, for example arranged in a common housing, or may be arranged as separate assemblies that follow one another in a flow direction.

A heat exchanger unit 22 is provided, which is assigned to the condenser unit 16. The water-containing fuel cell exhaust gas B_{w} which has been discharged from the fuel cell 12 and which is fed to the condenser unit 16 can flow through the heat exchanger unit 22 upstream of the condenser unit 16, that is, between the fuel cell 12 and the condenser unit 16 as viewed in a flow direction. Furthermore, the water-depleted fuel cell exhaust gas Bₑ that has been discharged from the condenser unit 16 can flow through the heat exchanger unit 22 before being discharged to the surroundings, such that thermal interaction occurs between the water-containing fuel cell exhaust gas B_{w} that is fed to the condenser unit 16 and the water-depleted fuel cell exhaust gas Bₑ that has been discharged from the condenser unit 16. Here, for efficient thermal interaction, the heat exchanger 22 may for example be configured as a cross-flow heat exchanger or as a counter-flow heat exchanger.

The water-containing fuel cell exhaust gas B_{w} that has been discharged from the fuel cell 12 at a relatively high temperature of up to 100° C. is also cooled, in the condenser unit 16, owing to the thermal interaction with the cooling medium K, with the result that the water-depleted fuel cell exhaust gas Bₑ that exits the condenser unit 16 or the separator unit 20 thereof is at a significantly lower temperature than the water-containing fuel cell exhaust gas B_{w} that is fed to the condenser unit 16. This has the result that the thermal interaction that occurs in the heat exchanger unit 22 leads to cooling of the water-containing fuel cell exhaust gas B_{w} that is fed to the condenser unit 16 and to warming of the water-depleted fuel cell exhaust gas Bₑ which has been discharged from the condenser unit 16 and which is emitted to the surroundings.

The fact that the water-containing fuel cell exhaust gas B_{w} is cooled upstream of the condenser unit 16, that is, before it is introduced into the condenser unit, means that the condensation of water contained, for example in water vapor form, in the water-containing fuel cell exhaust gas B_{w}, by further cooling via the cooling medium K in the condenser unit 16, is assisted, such that the condenser unit can be operated more efficiently for condensing out and subsequently separating off water W.

The warming of the water-depleted fuel cell exhaust gas Bₑ before it is discharged to the surroundings has the effect that the relative humidity of the water-depleted fuel cell exhaust gas is reduced to a value significantly below 100%. If the water-depleted fuel cell exhaust gas Bₑ exits the fuel cell exhaust-gas system 14 with a relative humidity of significantly below 100%, for example in the region of or below 90%, and in so doing comes into contact with the ambient air, which is for example at a significantly lower temperature, a spontaneous increase of the relative humidity, and thus an attainment or overshooting of a degree of saturation of 100%, are avoided. This in turn results in considerably reduced fog formation when the water-depleted fuel cell exhaust gas Bₑ, which still contains a residual quantity of water or water vapor, emerges into the surroundings.

The water W that is separated off at the separator unit 20 may be collected in a water tank and/or discharged in liquid form to the surroundings. Alternatively or in addition, the water W or at least a fraction of the water W may for the purposes of humidifying the fuel cell 12, be fed back into the fuel cell, and for example introduced together with the cathode gas into the cathode region. It is also possible for the water W to be utilized in a vehicle as washer fluid for a windshield wiper, or for cleaning sensors for autonomous driving. The water may also be utilized for humidifying the air that is to be introduced, having been thermally conditioned via an air-conditioning system, into a vehicle interior compartment.

FIG. 2 shows an alternative configuration of a fuel cell exhaust-gas system 14, which may be used in particular if the fuel cell 12 illustrated in FIG. 1 has two stack modules that each generate a flow of water-containing fuel cell exhaust gas B_{w1} and B_{w2} respectively. Alternatively, these two flows of water-containing fuel cell exhaust gas B_{w1}, B_{w2} may be generated by splitting of the flow of water-containing fuel cell exhaust gas B_{w} that is generated by the fuel cell 12 that is constructed, for example, with only one module.

The fuel cell exhaust-gas system 14 illustrated in FIG. 2 includes two condenser units 16′, 16″, each having a condenser region 18′, 18″ and a separator unit 20′, 20″ adjoining the condenser region in a downstream direction. Upstream of the first condenser unit 16′, the water-containing fuel cell exhaust gas B_{W1} flows through a first heat exchanger unit 22′. Likewise, upstream of the second condenser unit 16″, the water-containing fuel cell exhaust gas B_{w2} flows through a second heat exchanger unit 22″.

The water-depleted fuel cell exhaust gas Bₑ₂ that has been discharged from the condenser unit 16″ also flows through the first heat exchanger unit 22′. Likewise, the water-depleted fuel cell exhaust gas Bₑ₁ that has been discharged from the first condenser unit 16′ also flows through the second heat exchanger unit 22″.

In the fuel cell exhaust-gas system 14 illustrated in FIG. 2, mutual thermal interaction between the fuel cell exhaust gas flowing through the first condenser unit 16′ and the fuel cell exhaust gas flowing through the second condenser unit 16″ is achieved. The thermal interaction already described above with reference to FIG. 1 takes place in each of the two heat exchanger arrangements 22′, 22″, with each flow of water-depleted fuel cell exhaust gas Bₑ₁, Bₑ₂ being warmed by the respectively associated flow of water-containing fuel cell exhaust gas B_{w2}, B_{w1}, and the latter being cooled in the process. It is also the case here that the water-depleted fuel cell exhaust gas Bₑ₁, Bₑ₂ that is respectively discharged to the surroundings has, owing to its elevated temperature, a relative humidity that has been reduced to significantly below 100%, and the formation of fog can thus be substantially suppressed.

Note that, for example if the fuel cell 12 includes more than two fuel cell modules or stacks, the number of fuel cell exhaust-gas flows that interact with one another may be correspondingly increased in the manner illustrated in FIG. 2. It is also possible, for example, for the flows of water-depleted fuel cell exhaust gas that are respectively discharged from two condenser units that act in parallel with one another to be conducted into the same heat exchanger unit in order to effect a thermal interaction, in the heat exchanger, with water-containing fuel cell exhaust gas.

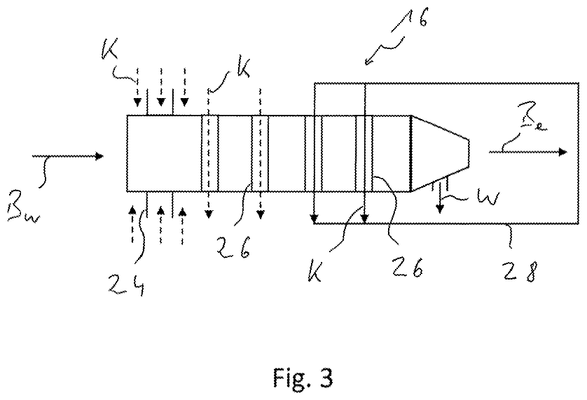

FIG. 3 is a diagrammatic illustration of the configuration of, for example, the condenser unit 16 of FIG. 1 or the condenser units 16′, 16″ of FIG. 2, in particular for thermal interaction with the cooling medium K. In the left-hand region of the condenser region 18 of the condenser unit 16 as illustrated in FIG. 3, heat transfer fins 24 are provided on the condenser unit 16, for example on the outside of a housing thereof, around which heat transfer fins the cooling medium K flows. Here, as cooling medium K, use is preferably made of ambient air, which is generally at a significantly lower temperature than the water-containing fuel cell exhaust gas B_{w} that is discharged from the fuel cell.

In the configuration variant illustrated in the middle region of FIG. 3, in the condenser unit 16 or in the condenser region 18 thereof, there are provided multiple cooling medium channels 26 through which the cooling medium K, provided again in the form of ambient air, can flow. Also, the water-containing fuel cell exhaust gas B_{w} that has been introduced into the condenser region 18 flows around the cooling medium channels 24 such that it can release heat to the cooling medium K.

In the configuration example illustrated on the right in FIG. 3, a liquid cooling medium K that circulates in a cooling medium circuit 28 flows through the cooling medium channels 26 that are provided in the condenser region 18. For example, the liquid cooling medium K may be a refrigerant which circulates in the circuit 28 and which, as in a refrigerant circuit of an air-conditioning system, changes between a liquid and a gaseous state of aggregation, and in so doing absorbs heat in the region of the cooling medium channels 26 and releases the heat, for example to the ambient air, in a region situated outside the condenser region 18 or, in order to further increase efficiency, transfers the heat to the water-depleted fuel cell exhaust gas Bₑ that exits the separator unit 20.

In particular if ambient air is used as cooling medium K, this may be conveyed by a fan so as to flow through and/or around the condenser region 18. It is furthermore particularly advantageous if, for such a flow of the ambient air through or around it, the condenser unit 16 or the condenser region 18 thereof is positioned in a vehicle such that an efficient air flow is generated by the relative wind alone. Here, provision may for example be made for the condenser unit 16 to be arranged in a front region of a vehicle, which can be easily impinged on by a flow of the ambient air, or in or under the underbody region of the vehicle, along which the ambient air flows while a vehicle is in motion.

With the configuration according to the disclosure of a fuel cell exhaust-gas system, particularly efficient operation thereof for separating off water that is contained in the fuel cell exhaust gas, and for preventing fog formation when the fuel cell exhaust gas emerges into the surroundings, is achieved. This advantage can be utilized both when such a fuel cell exhaust-gas system is used in a static system and when it is used in a vehicle. Owing to the thermal interaction that is introduced using one or more heat exchanger units, it is made possible for the fuel cell exhaust-gas system to be operated efficiently in a wide range of possible operating situations, in particular ambient temperatures, and with only little or no fog formation, which is advantageous in particular in the case of use in a vehicle, because an adverse effect on other road users owing to fog formation can be avoided.

It is understood that the foregoing description is that of the preferred embodiments of the invention and that various changes and modifications may be made thereto without departing from the spirit and scope of the invention as defined in the appended claims.

1. A fuel cell exhaust-gas system comprising:
a condenser for receiving water-containing fuel cell exhaust gas discharged from a fuel cell and for discharging water-depleted fuel cell exhaust gas;
said condenser including a separator for separating off water that has been condensed out of said water-containing fuel cell exhaust gas fed to said condenser;
a heat exchanger configured to permit said water-containing fuel cell exhaust gas fed to said condenser and said water-depleted fuel cell exhaust gas discharged from said condenser to flow through said heat exchanger in order for heat of said water-containing fuel cell exhaust gas to be transferred to said water-depleted fuel cell exhaust gas.

2. The fuel cell exhaust-gas system of claim 1, further comprising:
at least two of said condensers and at least two of said heat exchangers;
wherein:
said water-containing fuel cell exhaust gas fed to a first condenser of said at least two condensers can flow through a first heat exchanger of said at least two heat exchangers;
wherein said water-containing fuel cell exhaust gas fed to a second condenser of said at least two condensers can flow through a second heat exchanger of said at least two heat exchangers;
wherein said water-depleted fuel cell exhaust gas discharged from said second condenser can flow through said first heat exchanger in order for heat of said water-containing fuel cell exhaust gas fed to said first condenser to be transferred to said water-depleted fuel cell exhaust gas discharged from said second condenser; and,
wherein said water-depleted fuel cell exhaust gas discharged from said first condenser can flow through said second heat exchanger in order for heat of said water-containing fuel cell exhaust gas fed to the second condenser to be transferred to said water-depleted fuel cell exhaust gas discharged from said first condenser.

3. The fuel cell exhaust-gas system of claim 1, wherein a cooling medium can flow through and/or around said condenser.

4. The fuel cell exhaust-gas system of claim 3, wherein said cooling medium includes ambient air.

5. The fuel cell exhaust-gas system of claim 3, wherein said cooling medium includes a cooling liquid.

6. The fuel cell exhaust-gas system of claim 3, wherein said condenser comprises at least one of the following: i) a multiplicity of cooling medium channels through which said cooling medium can flow; and, ii) a multiplicity of heat transfer fins around which said cooling medium can flow.

7. The fuel cell exhaust-gas system of claim 1, wherein said fuel cell exhaust-gas system is for a vehicle.

8. A fuel cell system comprising:
a fuel cell; and,
a fuel cell exhaust-gas system communicating with said fuel cell;
said fuel cell exhaust-gas system including:
a condenser for receiving water-containing fuel cell exhaust gas discharged from a fuel cell and for discharging water-depleted fuel cell exhaust gas;
said condenser including a separator for separating off water that has been condensed out of said water-containing fuel cell exhaust gas fed to said condenser;
a heat exchanger configured to permit said water-containing fuel cell exhaust gas fed to said condenser and said water-depleted fuel cell exhaust gas discharged from said condenser to flow through said heat exchanger in order for heat of said water-containing fuel cell exhaust gas to be transferred to said water-depleted fuel cell exhaust gas.

9. The fuel cell system of claim 8, wherein said fuel cell system is for a vehicle.
